(19) United States
(12) Patent Application Publication
(10) Pub. No.: US 2014/0186615 A1
(43) Pub. Date: Jul. 3, 2014

(54) TRANSPARENT CONDUCTIVE SUBSTRATE, METHOD OF FABRICATING THE SAME, AND TOUCH PANEL HAVING THE SAME

(71) Applicant: SAMSUNG CORNING PRECISION MATERIALS CO., LTD., Gyeongsangbuk-do (KR)

(72) Inventors: Jin-Soo AN, ChungCheongNam-Do (KR); Jung Hong OH, ChungCheongNam-Do (KR); Jae Hong LEE, ChungCheongNam-Do (KR); Chang Moog RIM, ChungCheongNam-Do (KR)

(73) Assignee: SAMSUNG CORNING PRECISION MATERIALS CO., LTD., Gyeongsangbuk-do (KR)

(21) Appl. No.: 14/140,320

(22) Filed: Dec. 24, 2013

(30) Foreign Application Priority Data
Dec. 27, 2012 (KR) 10-2012-0154400

(51) Int. Cl. G02F 1/1333

(52) U.S. Cl. CPC G02F 1/13338
USPC 428/332

(57) ABSTRACT

A transparent conductive substrate, a method of fabricating the same, and a touch panel including the same. The transparent conductive substrate includes a first thin film layer, a second thin film layer and a transparent conductive film which are sequentially provided on a glass substrate. The first thin film layer has a refractive index ranging from 2.2 to 2.7 at a wavelength of 550 nm and a thickness ranging from 7.6 to 9.4 nm. The second thin film layer has a refractive index ranging from 1.4 to 1.5 at a wavelength of 550 nm and a thickness ranging from 37 to 46.2 nm. The transparent conductive film is made of a transparent conductive material having a refractive index material ranging from 1.8 to 2.0 at a wavelength of 550 nm. The thickness of the transparent conductive film ranges from 24 to 38.5 nm.

### CROSS REFERENCE TO RELATED APPLICATION

The present application claims priority from Korean Patent Application Number 10-2012-0154400 filed on Dec. 27, 2012, the entire contents of which are incorporated herein for all purposes by this reference.

### BACKGROUND OF THE INVENTION

1. Field of the Invention

The present invention relates to a transparent conductive substrate, a method of fabricating the same, and a touch panel including the same, and more particularly, to a transparent conductive substrate used in a touch panel, a method of fabricating the same, and a touch panel including the same.

2. Description of Related Art

In general, a touch panel refers to a device that is disposed on the surface of a display device, such as a cathode ray tube (CRT), a liquid crystal display (LCD), a plasma display panel (PDP), an electroluminescence (EL) device or the like, such that a signal can be outputted when a user touches the touch panel with a finger or an input device such as a stylus while watching the screen of the display device. Recently, the touch panel is widely used in a variety of electronic devices, such as a personal digital assistant (PDA), a notebook computer, an optical amplifier (OA) device, a medical instrument or a car navigation system.

Such touch panels are divided into a resistance film type, a capacitance type, an ultrasonic wave type, an infrared (IR) radiation type and the like depending on the technology of detecting a position.

The resistance film type is configured such that two substrates, each of which is coated with a transparent electrode layer (an indium tin oxide (ITO) film), are joined together so that the transparent electrode layers face each other on both sides of a dot spacer. When a finger, a pen or the like touches the upper substrate, a signal for determining the position is applied. When the upper substrate adjoins the transparent electrode layer of the lower substrate, the position is determined by detecting the electrical signal. The advantages of this technology are a high response rate and economical competitiveness, whereas the disadvantages are low endurance and fragility.

The capacitance type is configured such that a transparent electrode is formed by coating one surface of a substrate film of a touch screen sensor with a conductive metal material, in which a certain amount of current is allowed to flow along the glass surface. When a user touches the screen, the touched position is determined by recognizing the position where the amount of current is changed due to the capacitance of the human body and calculating the size of the touched position. The advantages of this technology are superior endurance and high transmittance, whereas the disadvantage is that it is difficult to operate the touch panel with a pen or a gloved hand since this technology uses the capacitance of the human body.

The ultrasonic wave type uses a piezoelectric device which is based on a piezoelectric effect, and determines the position by calculating the distance from each input point by generating surface waves in the X and Y directions in an alternating fashion from the piezoelectric device in response to touching of the touch panel. While this technology realizes high definition and high light transmittance, the drawbacks are that the sensor is vulnerable to contamination and liquid.

The IR radiation type has a matrix structure in which a plurality of light-emitting devices and a plurality of photodetectors are disposed around a panel. When light is interrupted by a user, input coordinates are determined by acquiring X and Y coordinates of the interrupted position. While this technology has a high light transmittance and strong endurance to external impacts and scratches, the drawbacks are the large size, the poor identification of an inaccurate touch and the slow response rate.

The resistance film type and the capacitance type are most popular among these technologies. These technologies use a transparent conductive substrate that is provided by coating a base substrate with a transparent conductive film made of, for example, indium tin oxide (ITO) in order to detect the touched position.

In this transparent conductive substrate, in order to improve the transmittance and prevent the shape of the pattern of the patterned transparent conductive film from being visually displayed, an index matching layer that includes a middle-refraction thin film and a low-refraction thin film is interposed between the base substrate and the transparent conductive film.

A technology for the index matching layer was disclosed in Korean Patent Application Publication No. 10-2011-0049553 (May 12, 2011).

In order to reduce the width of the pattern formed on the transparent conductive film, the resistivity of the transparent conductive film is required to be low. In addition, in order to have low resistivity, the thickness of the transparent conductive film is required to be increased. However, this causes the problem of decreased transmittance. In addition, when a thick transparent conductive film is provided on the index matching layer, the thickness of the entire transparent conductive substrate is increased and the thickness of the touch panel is also increased, which are problematic.

The information disclosed in the Background of the Invention section is provided only for better understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a transparent conductive substrate in which optical properties and electrical properties are optimized, a method of fabricating the same, and a touch panel including the same.

In an aspect of the present invention, provided is a transparent conductive substrate that includes: a glass substrate; a first thin film layer provided on the glass substrate, wherein the refractive index of the first thin film layer ranges from 2.2 to 2.7 at a wavelength of 550 nm, and the thickness of the first thin film layer ranges from 7.6 to 9.4 nm; a second thin film layer provided on the first thin film layer, wherein the refractive index of the second thin film layer ranges from 1.4 to 1.5 at a wavelength of 550 nm, and the thickness of the second thin film layer ranges from 37 to 46.2 nm; and a transparent conductive film provided on the second thin film, wherein the transparent conductive film is made of a transparent conductive material, the refractive index of the transparent conductive material ranges from 1.8 to 2.0 at a wavelength of 550 nm, and a thickness of the transparent conductive film ranges from 24 to 38.5 nm.

According to an embodiment of the present invention, the first thin film layer may be made of Nb₂O₅.

The second thin film layer may be made of SiO₂.

The transparent conductive material may contain indium tin oxide (ITO).

The transparent conductive film may include a patterned area in which the transparent conductive material is removed and a non-patterned area in which the transparent conductive material is not removed.

The difference in average reflectance between the patterned area and the non-patterned area may be 1% or less at a wavelength ranging from 400 to 700 nm.

The glass substrate may be made of flexible glass.

The sheet resistance of the transparent conductive film may be 50 Ω/□ or less.

In another aspect of the present invention, provided is a method of fabricating a transparent conductive substrate. The method includes the following steps of: forming a first thin film layer on a flexible glass substrate, the first thin film layer comprising Nb₂O₅, and the thickness of the first thin film layer ranging from 7.6 to 9.4 nm; forming a second thin film layer on the first thin film layer, the second thin film layer comprising SiO₂, and the thickness of the second thin film layer ranging from 37 to 46.2 nm; and forming a transparent conductive film on the second thin film layer, the transparent conductive film comprising indium tin oxide (ITO), and the thickness of the transparent conductive film ranging from 24 to 38.5 nm. The first thin film layer, the second thin film layer and the transparent conductive film are formed through roll-to-roll sputtering deposition.

The method may further include the step of crystallizing the transparent conductive film through annealing after the step of forming the transparent conductive film.

The method may further include the step of patterning the transparent conductive film into a patterned area in which the transparent conductive film is removed and a non-patterned area in which the transparent conductive film is not removed after the step of forming the transparent conductive film and before the step of crystallizing the transparent conductive film.

In a further aspect of the present invention, provided is a touch panel that includes the above-described transparent conductive substrate.

According to embodiments of the present invention, the transmittance of the transparent conductive film is 87.5% or greater at a wavelength of 550 nm, and the average transmittance of the transparent conductive film is 87% or greater at a wavelength ranging from 400 to 700 nm. In addition, the transmittance of b* (D65) in CIE Lab is 1 or less. When the transparent conductive film is patterned, the difference in average reflectance between the patterned area and the non-patterned area is 1% or less at a wavelength ranging from 400 to 700 nm.

In addition, since the first thin layer, the second thin film layer and the transparent conductive film are sequentially formed on the glass substrate using the roll-to-roll equipment, the fabrication efficiency of the transparent conductive substrate can be improved.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a schematic cross-sectional view showing a transparent conductive substrate according to an embodiment of the present invention;

FIG. 2 to FIG. 5B are graphs showing the transmittance and reflectance spectra of a transparent conductive substrate according to an embodiment of the present invention; and

FIG. 6 is a schematic flow diagram showing a method of fabricating a transparent conductive substrate according to an embodiment of the present invention.

### DETAILED DESCRIPTION OF THE INVENTION

Reference will now be made in detail to a transparent conductive substrate, a method of fabricating the same, and a touch panel including the same according to the present invention, embodiments of which are illustrated in the accompanying drawings and described below, so that a person having ordinary skill in the art to which the present invention relates can easily put the present invention into practice.

Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

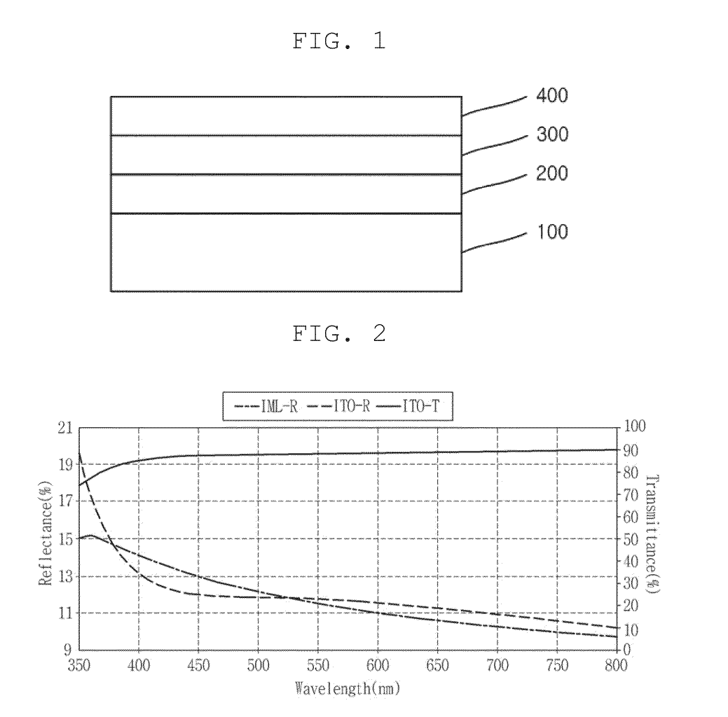

FIG. 1 is a schematic cross-sectional view showing a transparent conductive substrate according to an embodiment of the present invention.

Referring to FIG. 1, the transparent conductive substrate according to this embodiment includes a glass substrate 100, a first thin film layer 200, a second thin film layer 300 and a transparent conductive film 400.

The glass substrate 100 is a base substrate, and preferably, is used as a cover substrate of a touch panel.

In general, the thickness of the glass substrate 100 is 1 mm or less, and the glass substrate 100 is made of high-transmittance soda-lime or alkali-free aluminosilicate. The glass has physical properties that overcome the limitations of plastic materials regarding, for example, transmittance, long-term endurance and touch sensation but has the drawback of being vulnerable to impacts. The touch panel is attached to a display part of a variety of instruments, and especially when attached to a small and thin device such as a mobile phone, it must be strong enough to guarantee endurance to external impacts. Accordingly, it is preferable to use the chemically toughened glass that is produced from a soda-lime glass through chemical treatment of substituting Na with K in order to increase strength. It is more preferable that the base substrate 100 be made of flexible glass. The extent of flexibility can be classified into ‘Curved(Durable)’, ‘Bendable’, ‘Rollable(Wearable)’, ‘Foldable(Full-Flexible)’ and ‘Disposable’. Glass with one of such properties can be called the flexible glass. For example, a 0.2 mm thick glass, its allowable stress being 50 Mpa, which can exhibit the curvature radius of 160 mm or less belongs to the flexible glass.

The first thin film layer 200 is provided on the glass substrate 100. The refractive index of the first thin film layer 200 ranges from 2.2 to 2.7 at a wavelength of 550 nm, and the thickness of the first thin film layer 200 ranges from 7.6 to 9.4 nm.

It is preferred that the first thin film 200 be made of Nb₂O₅, and that the thickness of the first thin film 200 be 8.5 nm.

The second thin film layer 300 is provided on the first thin film layer 200. The refractive index of the second thin film layer 300 ranges from 1.4 to 1.5 at a wavelength of 550 nm, and the thickness of the second thin film layer 300 ranges from 37 to 46.2 nm.

It is preferred that the second thin film layer 300 be made of SiO₂, and that the thickness of the second thin film layer 300 be 40 nm.

The first thin film layer 200 and the second thin film layer 300 form an index matching layer, whereby a pattern which will be formed due to etching of the transparent conductive film 400 can be prevented from being visually recognized.

The transparent conductive film 400 is formed on the second thin film layer 300, is made of a transparent conductive material. The refractive index of the transparent conductive material ranges from 1.8 to 2.0 at a wavelength of 550 nm, and the thickness of the transparent conductive material ranges from 24 to 38.5 nm.

It is preferred that the sheet resistance of the transparent conductive film 400 be 50 Ω/□ or less. In addition, the transparent conductive film 400 can be made of indium tin oxide (ITO) that has high conductivity and transmittance. In this case, it is preferred that the thickness of the transparent conductive film 400 be 35 nm.

When the transparent conductive substrate according to the present invention is used for the touch panel, the transparent conductive film 400 acts as an electrode for detecting a touched position. For this, the transparent conductive film 400 can be patterned such that it includes a patterned area in which the transparent conductive material is removed and a non-patterned area in which the transparent conductive material is not removed.

In this case, at a wavelength ranging from 400 to 700 nm, the difference in average reflectance between the patterned area and the non-patterned area is preferably 1% or less.

In the transparent conductive substrate according to this embodiment, the first thin film layer 200, the second thin film layer 300 and the transparent conductive film 400 are sequentially layered on the glass substrate 100. Here, the first thin film layer 200 is made of Nb₂O₅ and has a thickness ranging from 7.6 to 9.4 nm, the second thin film layer 300 is made of SiO₂ and has a thickness ranging from 37 to 46.2 nm, and the transparent conductive film 400 is made of ITO and has a thickness ranging from 24 to 38.5 nm. In this transparent conductive substrate, the transmittance at 550 nm is 87.5% or greater, the average transmittance area at a wavelength ranging from 400 to 700 nm is 87% or greater, and the transmittance of b* (D65) in CIE Lab is 1 or less. In addition, when the transparent conductive film is patterned, the difference in average reflectance between the patterned area and the non-patterned area is 1% or less at a wavelength ranging from 400 to 700 nm.

Reference will now be made in more detail to some examples of the present invention. It should be understood, however, that the following examples are illustrative only and are not intended to limit the scope of the present invention.

### EXAMPLE 1

FIG. 2 is a graph showing the transmittance and reflectance spectra of a transparent conductive substrate according to an embodiment of the present invention in which a first thin film layer 200 which is made of Nb₂O₅ and has a thickness of 8.5 nm, a second thin film layer 300 which is made of SiO₂ and has a thickness of 40 nm, and a transparent conductive film 400 which is made of indium tin oxide (ITO) and has a thickness of 35 nm are sequentially layered on a glass substrate 100. Referring to FIG. 2, IML-R indicates the reflectance of the patterned area in which the transparent conductive film 400 is removed, ITO-R indicates the reflectance of the non-patterned area in which the transparent conductive film 400 is not removed, and ITO-T indicates the transmittance of the non-patterned area in which the transparent conductive film 400 is not removed.

As shown in FIG. 2, it can be appreciated that, in the transparent conductive substrate according to an embodiment of the present invention, the transmittance at 550 nm wavelength is 88.01% or greater, the average transmittance at a wavelength ranging from 400 to 700 nm is 87.85%, and the difference in average reflectance between the patterned area and the non-patterned area is 0.6% or less at a wavelength ranging from 400 to 700 nm. In addition, in this transparent conductive substrate, the transmittance of b* (D65) in CIE Lab is 0.65 or less.

### EXAMPLE 2

An experiment, as in Example 2, was performed in order to examine the optical properties of a transparent conductive substrate according to an embodiment of the present invention, taking into account variations in the thickness of ITO.

Table 1 presents the stacked structure of transparent conductive substrates according to an embodiment of the present invention, and Table 2 presents the optical properties of the transparent conductive substrates.

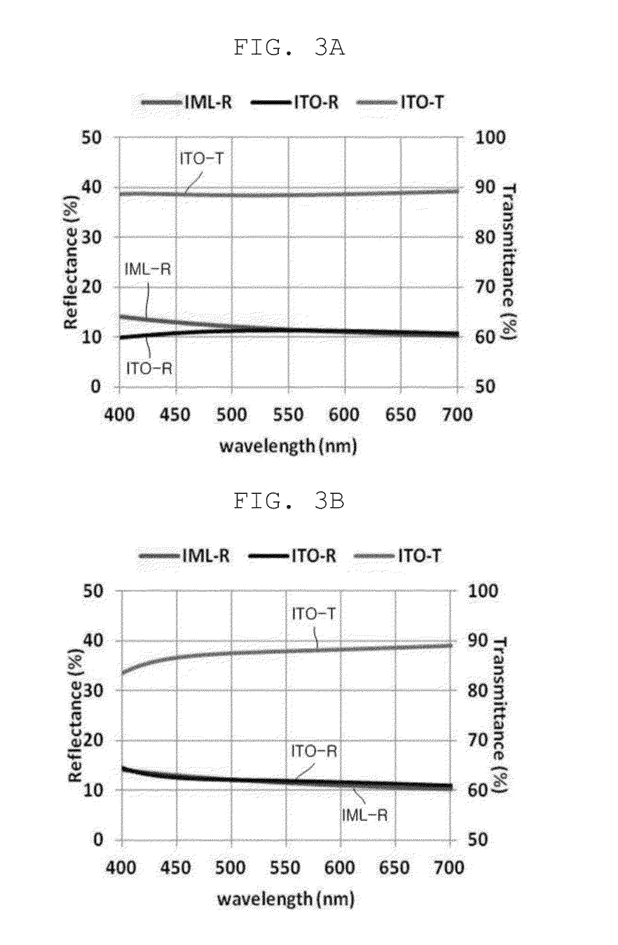

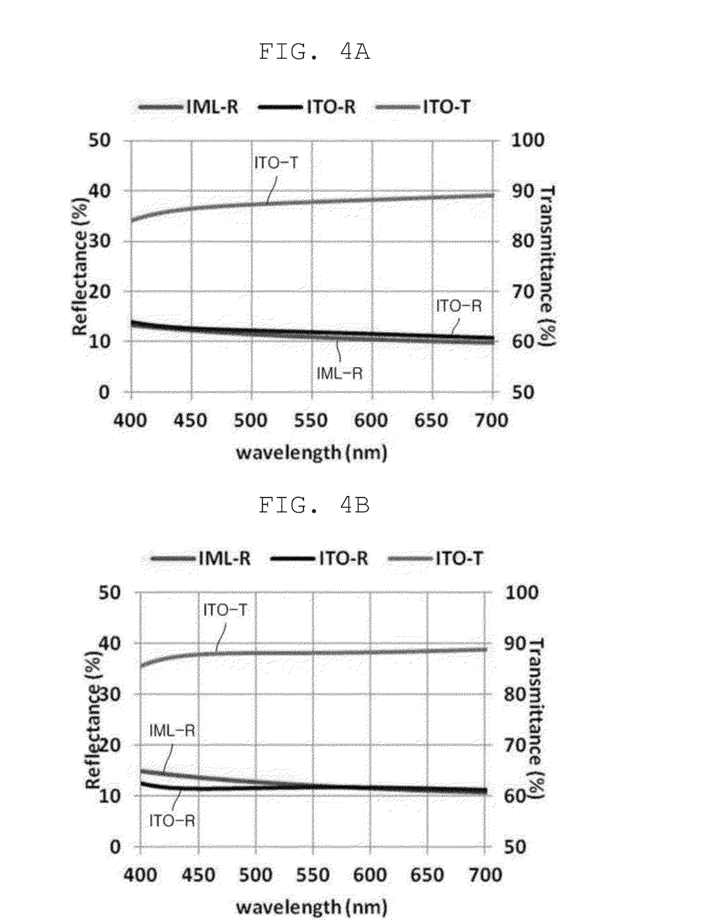

In addition, FIG. 3A and FIG. 3B are graphs showing reflectance and transmittance spectra of the transparent conductive substrates of Sample 1 and Sample 2.

TABLE 1

| | |
|---|---|
| Sample 1 | Sample 2 |

| | | | | |
|---|---|---|---|---|
| ITO | 24.0 | nm | 38.5 | nm |
| SiO₂ | 40 | nm | 40 | nm |
| Nb₂O₅ | 8.5 | nm | 8.5 | nm |

| | | |
|---|---|---|
| Glass | — | — |

TABLE 2

| | Sample 1 | Sample 2 |
|---|---|---|
| Difference in average reflectance | 0.99 | 0.46 |
| between patterned area and non- | | |
| patterned area at a wavelength ranging | | |
| from 400 to 700 nm | | |
| Transmittance at 550 nm | 88.47 | 87.82 |
| Transmittance of b* (D65) | −0.0576 | 0.9977 |
| Average transmittance at a wavelength | 88.68 | 87.50 |
| ranging from 400 to 700 nm | | |

Referring to Table 1, Table 2, FIG. 3A and FIG. 3B, as the thickness of ITO increases, the difference in average reflectance between the patterned area and the non-patterned area decreases, whereas the average transmittance at a wavelength ranging from 400 to 700 nm decreases. In addition, it can be appreciated that the transmittance of b* (D65) in CIE Lab increases.

### EXAMPLE 3

An experiment, as in Example 3, was performed in order to examine the optical properties of a transparent conductive substrate according to an embodiment of the present invention, taking into account variations in the thickness of Nb₂O₅.

Table 3 presents the stacked structure of transparent conductive substrates according to an embodiment of the present invention, and Table 4 presents the optical properties of the transparent conductive substrates.

In addition, FIG. 4A and FIG. 4B are graphs showing reflectance and transmittance spectra of the transparent conductive substrates of Sample 3 and Sample 4.

TABLE 3

| | |
|---|---|
| Sample 3 | Sample 4 |

| | | | | |
|---|---|---|---|---|
| ITO | 35.0 | nm | 35.0 | nm |
| SiO₂ | 40 | nm | 40 | nm |
| Nb₂O₅ | 7.6 | nm | 9.4 | nm |

| | | |
|---|---|---|
| Glass | — | — |

TABLE 4

| | Sample 3 | Sample 4 |
|---|---|---|
| Difference in average reflectance | 0.71 | 0.98 |
| between patterned area and non- | | |
| patterned area at a wavelength ranging | | |
| from 400 to 700 nm | | |
| Transmittance at 550 nm | 87.88 | 88.14 |
| Transmittance of b* (D65) | 0.9972 | 0.3257 |
| Average transmittance at a wavelength | 87.64 | 88.06 |
| ranging from 400 to 700 nm | | |

Referring to Table 3, Table 4, FIG. 4A and FIG. 4B, as the thickness of Nb₂O₅ increases, the difference in average reflectance between the patterned area and the non-patterned area increases, whereas the average transmittance at a wavelength ranging from 400 to 700 nm increases. In addition, it can be appreciated that the transmittance of b* (D65) in CIE Lab decreases.

### EXAMPLE 4

An experiment, as in Example 4, was performed in order to examine the optical properties of a transparent conductive substrate according to an embodiment of the present invention, taking into account variations in the thickness of SiO₂.

Table 5 presents the stacked structure of transparent conductive substrates according to an embodiment of the present invention, and Table 6 are values that present the optical properties of the transparent conductive substrates.

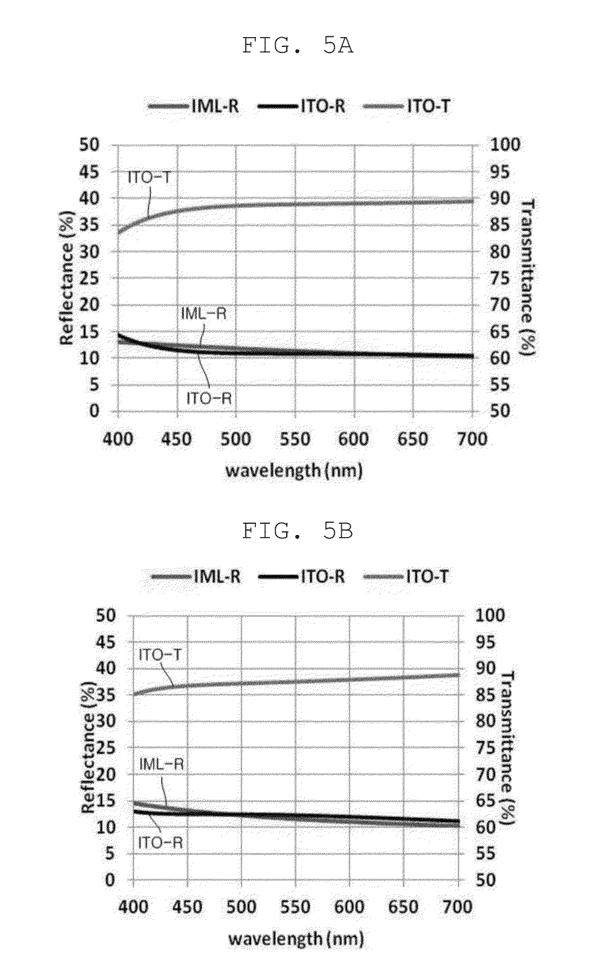

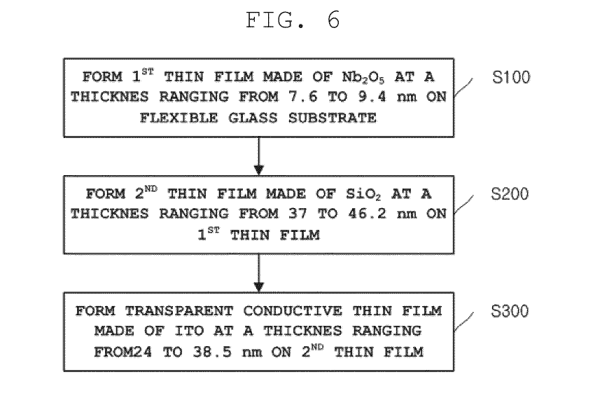

In addition, FIG. 5A and FIG. 5B are graphs showing reflectance and transmittance spectra of the transparent conductive substrates of Sample 5 and Sample 6.

TABLE 5

| | |
|---|---|
| Sample 5 | Sample 6 |

| | | | | |
|---|---|---|---|---|
| ITO | 35.0 | nm | 35.0 | nm |
| SiO₂ | 37.5 | nm | 46.2 | nm |
| Nb₂O₅ | 8.5 | nm | 8.5 | nm |
| Glass | — | | — | |

TABLE 6

| | Sample 5 | Sample 6 |
|---|---|---|
| Difference in average reflectance | 0.80 | 0.46 |
| between patterned area and non- | | |
| patterned area at a wavelength ranging | | |
| from 400 to 700 nm | | |
| Transmittance at 550 nm | 87.51 | 88.95 |
| Transmittance of b* (D65) | 0.6067 | 0.9982 |
| Average transmittance at a wavelength | 87.47 | 88.46 |
| ranging from 400 to 700 nm | | |

Referring to Table 5, Table 6, FIG. 5A and FIG. 5B, as the thickness of SiO₂ increases, the difference in average reflectance between the patterned area and the non-patterned area decreases, whereas the average transmittance at a wavelength ranging from 400 to 700 nm increases. In addition, it can be appreciated that the transmittance of b* (D65) in CIE Lab increases.

FIG. 6 is a schematic flow diagram showing a method of fabricating a transparent conductive substrate according to an embodiment of the present invention.

Referring to FIG. 6, the method of fabricating a transparent conductive substrate according to this embodiment includes step S100 of forming a first thin film layer made of Nb₂O₅ at a thickness ranging from 7.6 to 9.4 nm on a flexible glass substrate, step S200 of forming a second thin film layer made of SiO₂ at a thickness ranging from 37 to 46.2 nm on the first thin film layer, and step of forming a transparent conductive film made of indium tin oxide (ITO) at a thickness ranging from 24 to 38.5 nm on the second thin film layer. Here, the first thin film layer, the second thin film layer and the transparent conductive film are formed through sputtering deposition.

The transparent conductive substrate according to this embodiment can be fabricated using roll-to-roll sputtering equipment which includes an unwinder roll, a winder roll and a sputtering part.

The unwinder roll and the winder roll unwind or wind the flexible glass substrate through cooperative rotation. A plurality of guide rolls are arranged at certain distances in order to facilitate control over tension when the flexible glass substrate is being rolled. The process of forming a transparent conductive film on the flexible glass substrate through sputtering deposition is performed using a sputtering part. The sputtering part can be implemented as a sputterer which includes targets and a cathode. The targets are respectively made of materials that are to form a first thin film layer, the second thin film layer and a transparent conductive film. The cathode is a power supply which discharges atoms of the targets.

In order to fabricate a transparent conductive substrate according to an embodiment of the present invention, first, a first thin film layer made of Nb₂O₅ is formed at a thickness ranging from 7.6 to 9.4 nm on one surface of the flexible glass substrate using the roll-to-roll sputtering equipment (S100). Afterwards, at S200, a second thin film layer made of SiO₂ is formed at a thickness ranging from 37 to 46.2 nm on the first thin film layer. Finally, at S300, a transparent thin film made of indium tin oxide (ITO) is formed at a thickness ranging from 24 to 38.5 nm on the second thin film layer.

The step S100 of forming the first thin film layer and the step S200 of forming the second thin film layer can be performed at a lower temperature than the step S300 of forming the transparent conductive film. It is preferred that the step S100 of forming the first thin film layer and the step S200 of forming the second thin film layer be performed at a temperature of 150° C. or below through sputtering deposition, and that the step S300 of forming the transparent conductive film be performed at a temperature of 250° C. or above through sputtering deposition.

Since the first thin film layer, the second thin film layer and the transparent conductive film are sequentially formed on the flexible glass substrate as such, the fabrication efficiency of the transparent conductive substrate can be improved. In addition, the use of sputtering deposition makes it possible to produce a thin film having strong bonding force and makes it easy to control the film thickness.

Furthermore, the method of fabricating a transparent conductive substrate according to an embodiment of the present invention can further include the step of crystallizing the transparent conductive film through annealing after the step S300 of forming the transparent conductive film.

The step of crystallizing the transparent conductive film can improve the transmittance and endurance of the transparent conductive film. The step of crystallizing the transparent conductive film can be performed at a temperature ranging from 250 to 350° C.

In addition, the method of fabricating a transparent conductive substrate according to an embodiment of the present invention can further include the step of patterning the transparent conductive film into a patterned area in which the transparent conductive film is removed and a non-patterned area in which the transparent conductive film is not removed after the step S300 of forming the transparent conductive film and before the step of crystallizing the transparent conductive film.

The step of patterning the transparent conductive film can include laminating the transparent conductive film in which coating is completed with a dry film photoresist, placing a pattern film in which predetermined pattern elements continuously intersect each other on the dry film photoresist, developing a dry film photoresist area by irradiating the dry film photoresist with ultraviolet (UV) radiation, and selectively peeling off the dry film photoresist area that is irradiated with UV radiation using an acidic or alkaline etching solution.

The foregoing descriptions of specific exemplary embodiments of the present invention have been presented with respect to the drawings. They are not intended to be exhaustive or to limit the present invention to the precise forms disclosed, and obviously many modifications and variations are possible for a person having ordinary skill in the art in light of the above teachings.

It is intended therefore that the scope of the present invention not be limited to the foregoing embodiments, but be defined by the Claims appended hereto and their equivalents.

What is claimed is:

1. A transparent conductive substrate comprising:
a glass substrate;
a first thin film layer provided on the glass substrate, wherein a refractive index of the first thin film layer ranges from 2.2 to 2.7 at a wavelength of 550 nm, and a thickness of the first thin film layer ranges from 7.6 to 9.4 nm;
a second thin film layer provided on the first thin film layer, wherein a refractive index of the second thin film layer ranges from 1.4 to 1.5 at a wavelength of 550 nm, and a thickness of the second thin film layer ranges from 37 to 46.2 nm; and
a transparent conductive film provided on the second thin film, wherein the transparent conductive film comprises a transparent conductive material, a refractive index of the transparent conductive material ranges from 1.8 to 2.0 at a wavelength of 550 nm, and a thickness of the transparent conductive film ranges from 24 to 38.5 nm.

2. The transparent conductive substrate of claim 1, wherein the first thin film layer comprises Nb₂O₅.

3. The transparent conductive substrate of claim 1, wherein the second thin film layer comprises SiO₂.

4. The transparent conductive substrate of claim 1, wherein the transparent conductive material comprises indium tin oxide.

5. The transparent conductive substrate of claim 1, wherein the transparent conductive film comprises a patterned area in which the transparent conductive material is removed and a non-patterned area in which the transparent conductive material is not removed.

6. The transparent conductive substrate of claim 5, wherein a difference in average reflectance between the patterned area and the non-patterned area is 1% or less at a wavelength ranging from 400 to 700 nm.

7. The transparent conductive substrate of claim 1, wherein the glass substrate comprises flexible glass.

8. The transparent conductive substrate of claim 1, wherein a sheet resistance of the transparent conductive film is 50 Ω/□ or less.

9. A touch panel comprising the transparent conductive substrate recited in any one of claim 1.
